(19) United States
(12) Patent Application Publication
(10) Pub. No.: US 2005/0080189 A1
(43) Pub. Date: Apr. 14, 2005

(54) Polymeric colorants

(76) Inventors: John Waters, Lakewood, OH (US); Apparao Jatla, Broadview Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/921,568

(22) Filed: Aug. 19, 2004

Related U.S. Application Data
(60) Provisional application No. 60/496,271, filed on Aug. 19, 2003.
(60) Provisional application No. 60/497,586, filed on Aug. 25, 2003.

(51) Int. Cl. C08L 67/02

(52) U.S. Cl. 525/165

(57) ABSTRACT

A method of coloring a thermoplastic resin without substantially altering its clarity comprising the steps of first, providing a melt comprising a thermoplastic resin, second, adding one or more polymeric colorants to the melt, and third, mixing the thermoplastic resin and the polymeric colorants to form a colored thermoplastic resin having substantially the same clarity as the uncolored thermoplastic resin. Also provided are methods of imparting deep color to a thermoplastic resin without substantially altering its clarity comprising the steps of first, providing a melt comprising a thermoplastic resin, second, adding one or more polymeric colorants to the melt, wherein the amount of colorant is sufficient to impart a deep color, and third, mixing the thermoplastic resin and the polymeric colorants to form a deeply colored thermoplastic resin. Also provided are colored thermoplastic resins made by the methods of the present invention.

### CROSS-REFERENCE TO RELATED APPLICATIONS

This application claims priority to U.S. Provisional Patent Applications Serial No. 60/496,271 filed Aug. 19, 2003 and Serial No. 60/497,586 filed Aug. 25, 2003, the entirety of each is incorporated herein by reference.

### BACKGROUND OF THE INVENTION

Thermoplastic resins are ubiquitous in today's world because of their versatility and many desirable characteristics, especially clarity. However, there exists no satisfactory way to impart color to thermoplastic resins while maintaining clarity without sacrificing colorfastness. Conversely, there exists no satisfactory means by which to impart color that is resistant to migration or exudation to thermoplastic resins without sacrificing clarity.

Pigments are typically used in polyolefin resins to minimize migration and extractability. However, since pigments do not dissolve into polyolefins during the processing, they generally do not migrate or extract, but also give poor transparency. Dyes may be preferred to traditional pigments in some instances because they provide higher tinctoral strength and better clarity since they melt and dissolve into thermoplastic resins during processing. However, traditional low molecular weight dyes when used in polyolefins migrate to the surface of the plastic and are typically easily extractable with various solvents or aqueous solutions.

One solution has been to use higher molecular weight alkoxylated dyes. However, the final physical form of the polymeric dyestuff, liquids at low molecular weights, extremely viscous liquids at higher molecular weights, and finally low melting, waxy semi-solids at still higher molecular weights, is very inconvenient to use. More importantly, the amount of chromophore achievable at a particular molecular weight is limited, which limits the overall tinctoral strength of the product.

Accordingly, a need exists for new colorants that could be used to impart color to thermoplastic resins that maintain the clarity of the resins, while maintaining their colorfastness to extraction, migration, and exudation. Additionally, there exists a need for polymeric colorants that can impart a high level of color, when desired, while still maintaining the clarity of the thermoplastic resin and still having good colorfastness. Additionally, there exists a need for polymeric colorants that provide dyed thermoplastic resins exhibiting good clarity and colorfastness, while at the same time, are in an easy to use solid form.

### SUMMARY OF THE INVENTION

The present invention provides methods for adding color to thermoplastic resins without adversely affecting the clarity of the colored resin. The method comprises incorporating one or more solid polymeric colorants comprising dye molecules incorporated into the backbone of a polymeric resin into a thermoplastic resin. Advantageously, since the polymeric colorants are solid and friable at room temperature, they may be ground to powders for ease of handling. When adding polymeric colorants to a thermoplastic resin, the clarity of the colored thermoplastic resin is substantially the same as before the addition of the polymeric colorant. Clarity may be measured using standard ASTM testing procedures. Preferably, the difference in clarity between a clear, uncolored thermoplastic resin, such as clarified polypropylene and the colored thermoplastic resin product is less than 10%. More preferably, the difference in clarity is less than 5%. Even more preferably, the difference in clarity is less than 1%. Even more preferably, the difference in clarity is less than 0.1%. The polymeric colorant is typically added to the thermoplastic resin at a level of less than 2% by weight. Preferably, the polymeric colorant is added to the thermoplastic resin at a level of less than 1% by weight. More preferably, the polymeric colorant is added to the thermoplastic resin at a level of less than 0.3% by weight. In addition to providing a thermoplastic resin with good clarity, the polymeric colorants used in the present method exhibit colorfastness to extractions and little or no migration or exudation.

The resins that form the polymeric colorants can be polyamides, polyamide-esters, polyesters, or combinations thereof. Preferably, the resins are polyester-amides. The polymeric resins can be straight-chain or branched. In one embodiment the polymeric resins comprise at least some branched polyamides. In another embodiment, the polymeric resins are linear polymers.

The polymeric colorants are formed by polymerizing one or more dyes into the backbone of the polymer. The monomers, other than the dyes, have at least two functional groups selected from amine groups, alcohol groups, and carboxylic acids. The dyes used are stable under polymerization conditions, and contain a structure that is capable of reacting into a polyamide, polyamide-ester, or polyester. In one preferred embodiment, the polymeric resin comprises a polyamide-ester. The dyes may be functionalized with one or more reactive groups.

The monomers, other than dyes, are selected from the group consisting of diamines, polyamines, carboxy-amines, alkanolamines, polyfunctional alkanolamines, dicarboxylic acids, polyfunctional or monofunctional alcohol monomers, and combinations thereof.

Preferred diamines include to polyether diamines (Jeffamines), ethylenediamine, 1-amino-3-aminomethyl-3,5,5-trimethyl cyclohexane (isophoronediamine), hexamethylenediamine, 1,12-dodecanediamine, bis(aminomethyl)-[2.2.1]bicycloheptane (norbornanediamine or NBDA), 2-methylpentamethylenediamine, 2-ethyltetramethylenediamine, 1,2-diaminocyclohexane, 1,3-diaminocyclohexane, cis 1,4-diaminocyclohexane, and trans 1,4-diaminocyclohexane. Preferred carboxy-amines include p-aminobenzoic acid and lactones, such as caprolactone. Preferred alkanolamines have the formula: OH—R″—NH₂, wherein R″ is straight or branched alkylene having 2-8 carbon atoms, particularly, but not limited to, ethanolamine, butanolamine, n-propanolamine, isopropanolamine. Preferred are monoethanolamine and monoisopropanolamine. Preferred dicarboxylic acids have the formula HOOC—R′″—COOH, wherein R′″ is a straight or branched alkylene having 3-20 carbon atoms, a cycloalkylene having 5-8 carbon atoms, a cycloalkylene group with straight chain or branched alkyl carboxy groups optionally having up to 3 ring substitutions which may be the same or different, selected from C₁-C₅ alkyl, monocyclic or bicyclic arylene having 6-10 carbon atoms, optionally up to 6 substitutions selected from C₁-C₅ alkyl, C₁-C₂ dialkyl ester, or a diacid formed by the monocylic or bicylcic arylene group. Preferred dicarboxylic acids include phthalic acid/phthalic anhydride, isophthalic acid, terephthalic acid, 2,6-naphthalene dicarboxylic acid, succinic acid/succinic anhydride, glutaric acid, adipic acid, cyclohexane dicarboxylic acid, dimethylisophthalate, dimethylphthalate, dimethylterephthalate, dimethyl 2,6-naphthalene dicarboxylate, dimethyladipate, dimethylglutarate, dimethylsuccinate, mixtures thereof. Preferred difunctional alcohols are of the formula: HO—R″″—OH, wherein R″″ is selected from C₂-C₂₀ straight chain or branched alkylene, C₅-C₈ cycloalkylene, and cycloalkylene having straight chain or branched alkyl groups optionally having up to three C₁-C₅ substitutions, which may be the same or different. Preferred difunctional alcohols include cyclohexandimethanol, ethylene glycol, and propylene glycol. The difunctional alcohol may be present in amounts from about 0-60%, preferably about 0.1-49%, and more preferably about 15-40%. Polyfunctional alcohols that may be used with the present invention include trimethylolpropane, pentaerythritol, and dipentaerythritol. Carboxy-alcohols that may be used with the present invention include p-hydroxybenzoic acid, 2-chloro-4-hydroxybenzoic acid, and salicylic acid.

In one specific embodiment, the polyamide pigment embodiment, at least one type of monomer contains an amine group and at least one type of monomer contains a carboxyl group; the monomers can have both the amine and carboxyl groups on a single monomer.

In a second specific embodiment, the polyamide ester pigment embodiment, at least one type of monomer contains an amine group, at least one type of monomer contains a carboxyl group, and at least one type of monomer contains an alcohol group. In this second embodiment the amine group, the carboxyl group, and the alcohol group can be present on the same monomer or different monomers.

In a third specific embodiment, the polyester pigment embodiment, at least one type of monomer contains a carboxyl group and at least one type of monomer contains an alcohol group. The carboxyl group and the alcohol group can be present in the same or different monomers.

The polymeric colorants of the present invention contain about 5 to about 75% dye, or chromophore, by weight. Preferably, the polymeric colorants contain about 10 to about 50% chromophore, by weight. In certain embodiments, the polymeric colorants contain at least 15% chromophore, by weight. The polymeric colorants of the present invention have a low acid number, that is, the acid number of the polymeric colorants is less than or equal to 60. Preferably, the acid number of the polymeric colorants is less than or equal to 50. Weight average molecular weights of the polymeric colorants are in the range from about 500 to about 100,000, preferably from about 700 to about 20,000, and more preferably from about 1000 to about 10,000.

In accordance with the present invention, chain terminators such as, but not limited to benzoic acid, cyclohexylamine, stearic acid, butanoic acid, and cyclic anhydrides, such as phthalic anhydride or succinic anhydride may be added. After polymerization the cooled resin may be ground to the desirable particle size, which is typically about 2 to 100 microns.

The method for preparing the colored thermoplastic resin comprises the steps of: a) providing a melt comprising a thermoplastic resin; b) adding one or more polymeric colorants to the melt; and c) mixing the thermoplastic resin and colorant to form the colored thermoplastic resin. In another embodiment, the method for preparing the colored thermoplastic resin comprises: a) providing a mixture comprising a thermoplastic resin and one or more polymeric colorants; b) melting the thermoplastic resin and polymeric colorant together; and c) mixing the thermoplastic resin and colorant to form the colored thermoplastic resin. In a preferred embodiment, the thermoplastic resin is a clear thermoplastic resin, such as clarified polypropylene. In accordance with the present invention, the polymeric colorants of the present invention do not impart cloudiness when incorporated into clear thermoplastic resins. The invention further comprises the colored thermoplastic resin prepared by the inventive processes.

The present invention also provides colored thermoplastic resins made in accordance with the present invention. The colored thermoplastic resin comprises a thermoplastic resin and a polymeric colorant of the present invention. In one embodiment, the dyed thermoplastic resin is a polyolefin. In an especially preferred embodiment, the dyed thermoplastic resin is clarified polypropylene. In another embodiment, the dyed thermoplastic resin is polyethylene terephthalate (PET). In accordance with the present invention, the polymeric colorant does not impart cloudiness to the thermoplastic resin. Specifically, the clarity of the colored thermoplastic resin is substantially the same. Clarity may be measured using standard ASTM testing procedures. Preferably, there is no more than, and preferably less than a 10% reduction in clarity between the colored thermoplastic resin and the uncolored thermoplastic resin. More preferably, there is no more than, and preferably less than a 5% reduction in clarity between the colored thermoplastic resin and the uncolored thermoplastic resin. Even more preferably, there is less than a 1% reduction in clarity. Even more preferably, there is less than a 0.1% difference in clarity.

The polymeric colorants that are used in the present invention may be added at levels necessary to impart deeper colors to thermoplastic resins than dyes currently available for coloring thermoplastic resins. Even when the polymeric colorants are added at levels to impart deep colors, the clarity of the colored thermoplastic resin is substantially the same as before the addition of the polymeric colorant. In addition, there is little to no dye migration in contrast to the dyes currently available. Thus, the present invention also provides a method for preparing thermoplastic resins with deep colors. The method comprises: a) providing a melt comprising a thermoplastic resin; b) adding one or more polymeric colorants to the melt; and c) mixing the thermoplastic resin and colorant to form the colored thermoplastic resin. Alternatively, the method for preparing a deeply colored thermoplastic resin comprises: a) providing a mixture comprising a thermoplastic resin and one or more polymeric colorants; b) melting the thermoplastic resin and polymeric colorant together; and c) mixing the thermoplastic resin and colorant to form the colored thermoplastic resin. The one or more colorants comprise up to about 2%, preferably up to about 1%, and more preferably up to about 0.3% by weight of the of colored thermoplastic resin.

In accordance with the present invention, thermoplastic resins colored with the inventive polymeric colorants exhibit very little dye migration. To test dye migration, polymeric colorants are incorporated into clarified polypropylene at a level of 0.25% at a molding temperature of 450° F. Migration tests may be performed by placing a 3 in² piece of molded polypropylene between two 0.005″ thick pieces of white plasticized vinyl sheeting under a 500 g weight at 80° C. for 24 hours. Color migration to the white vinyl is noted as a color difference (Delta E) between the white vinyl and the color value imparted to the white vinyl during the test. The thermoplastic resin colored with the inventive polymeric colorants preferably have a color migration value, measured as Delta E, of less than 4. More preferably, the colored thermoplastic resin has a color migration value of less than 2.5. More preferably, the colored thermoplastic resin has a color migration value of less than 1.5. Even more preferably, the colored thermoplastic resin has a color migration value of less than 1. And even more preferably, the colored thermoplastic resin has a color migration value of less than 0.5.

The present invention further provides methods of preparing polymeric colorants that add color to polymeric resins without substantially altering the clarity of the polymeric resin. The inventive polymeric colorants are especially useful for coloring clear polymeric resins, such as clarified polypropylene, but can be used with a variety of polymeric resins, including but not limited to polyolefins and polyethylene terephthalate. The methods of the present invention comprise the steps of a) adding the monomers and dyes to a reaction vessel, and b) reacting the monomers and dyes to form a polymeric colorant wherein the dyes are incorporated into the polymeric backbone. In one embodiment, the monomers and the dyes are added to the reaction vessel at the same time. In another embodiment, the monomers are added to the reaction vessel, and the polymerization reaction is started. The dyes are then added to the reaction vessel after the polymerization reaction has started, but before polymerization is complete. The molecular weight of the polymer is controlled by regulation of the reaction time and temperature. Alternatively, the molecular weight can be controlled through the use of chain terminators and polyfunctional monomers. Optionally, catalysts to promote esterification or amidization may be used. A final step in the preparation of the polymeric colorants is grinding the polymeric colorants to a size of from about 2 to about 100 microns. Grinding is done in a conventional manner.

The present invention also relates to the polymeric colorants of the present invention. The polymeric colorants are useful for coloring thermoplastic resins without substantially altering the clarity of the thermoplastic resin. Such polymeric colorants comprise one or more polymers selected from the group consisting of polyamides, polyamide-esters, polyesters, and combinations thereof, and from 5 to 75% by weight of a chromophore. The chromophores are chosen such that they are stable under polymerization conditions and contain a structure that is capable of reacting into a polyester or polyamide-polyester. The chromophore is incorporated into the backbone of the polymer. In certain preferred embodiments, the chromophore is selected from the group consisting of benzodifuranones, diketopyrrolopyrroles (DPP), quinacridones, anthraquinones, xanthenes, thioxanthenes, naphthalimides, coumarins, perylenes, methines, and azo chromophores. The chromophore may be formed in situ or may be added as a discreet monomer. Preferably, the chromophore is added as a discreet monomer.

### DETAILED DESCRIPTION OF THE INVENTION

The present invention relates to polymeric colorants for imparting color to thermoplastic resins without substantially altering the clarity of the thermoplastic resins. The polymeric colorants of the present invention are especially useful for coloring thermoplastic resins that have high clarity, such as clarified polypropylene. Advantageously, the polymeric colorants of the present invention are solids at room temperature, making them easier to use than polymeric dyes that are liquid at room temperature. The polymeric resins also exhibit very little migration or exudation when used to impart color to thermoplastic resins. The present invention also relates to methods of coloring thermoplastic resins without substantially altering the clarity of the thermoplastic resin. Also provided are methods for imparting deep “gem-tone” colors to thermoplastic resins while maintaining the clarity of the thermoplastic resins.

The polymeric colorant of the present invention comprise polymers that comprise polymerized units of dye; the dye is incorporated into the backbone of the polymer chain by covalent bonding. Since the dye is actually incorporated into the backbone, it is technically a monomer; however for clarity, as used herein, the term “monomer” means a monomer, other than the dye, which polymerizes to form the polymeric colorant. As used herein, the term “monomer” includes units such as dimers, trimers, and other oligomers.

The polymeric colorants of the present invention may be used to impart different levels of color intensity, from less intense color to deep or jewel-toned color, to thermoplastic resins without substantially affecting the clarity of the resins. It will be recognized by those skilled in the art that the amount of dye added to produce a particular color intensity will vary depending on such factors as the specific dyes copolymerized in the polymeric colorant as well as the amount of the dye that is copolymerized into the specific polymeric colorant.

In accordance with the present invention, the polymeric colorants and methods described herein may be used to color clear thermoplastic resins, such as clarified polypropylene, without substantially altering the clarity of the thermoplastic resin. Clarity measurements may be done visually, wherein the clarity is described as excellent when the clarity of the colored clarified polypropylene is the same clarity as the uncolored clarified polypropylene as determined visually. The clarity is described as good when the clarity of the colored clarified polypropylene is slightly more opaque than the clarity as the colored clarified polypropylene as determined visually. A percent difference in clarity may be determined using standard ASTM testing procedures, known to those skilled in the art. Preferably, the difference in clarity between the uncolored colored clarified polypropylene and the colored clarified polypropylene is less than 10%. More preferably, the difference in clarity between the uncolored colored clarified polypropylene and the colored clarified polypropylene is less than 5%. Even more preferably, the difference in clarity between the uncolored colored clarified polypropylene and the colored clarified polypropylene is less than 1%. Even more preferably, the difference in clarity between the uncolored colored clarified polypropylene and the colored clarified polypropylene is less than 0.1%.

The Polymerizable Dye

Useful polymerizable dyes are chromophores that are stable under polymerization conditions and contain a structure that is capable of reacting into a polyester or polyamide-polyester. Typical dyestuff radicals are benzodifuranones, diketopyrrolopyrroles (DPP), quinacridones, anthraquinones, xanthenes, thioxanthenes, naphthalimides, coumarins, perylenes, methines, and azo Chromophores. Typical polymerizable groups are hydroxyls, amines, epoxies, carboxylic acids and their corresponding esters, amides or anhydrides. Chromophores may be functionalized with one or more reactive groups. The dye may be either formed in situ without purification prior to the polymerization reaction or may be added as a discreet monomer. The latter is generally preferred to remove impurities and by-products formed during the dye reaction.

The Monomers

The monomers used to form the polymeric pigment of the present invention each contain at least two functional groups. The functional groups are amine groups, alcohol groups and carboxylic acid groups. In the polyamide pigment embodiment at least one type of monomer contains an amine group and at least one monomer contains a carboxyl group; the monomers can have both the amine group and the carboxyl group on a single monomer. In the polyamide ester pigment embodiment, at least one type of monomer contains an amine group and at least one monomer contains a carboxylic acid group and at least one monomer contains an alcohol group. The alcohol group, the carboxyl group and the amine group can be present on the same monomer or on different monomers. The polyester pigment embodiment contains polymerized monomer in which at least one type of monomer had a carboxyl group and at least one monomer had an alcohol group; the alcohol group and the carboxyl group can be present on the same monomer, or different monomers.

The Diamine Monomers

The diamine monomers, while not essential to the performance of the polymeric colorants, serve to increase the glass transition temperature of the polymeric colorant thereby improving the friability and the storage stability of the resultant powders. Colorants that contain diamine monomers in their backbone tend to not sinter together under warm or humid conditions.

The diamine monomers are the preferred monomer for the source of amine groups. The diamine monomers have the general formula:
H₂N—R—NH₂
wherein R is a straight or branched chain alkylene group of from 2 to 20 carbon atoms, or a cycloalkylene group having from 5 to 8 preferably of from 5 to 6 carbon atoms or a cycloalkylene group with straight or branched alkyl amino groups additionally having up to three ring substitutions which may be the same or different, such substitution groups selected from the group consisting of C₁-C₅ alkyl groups, or a bicycloaliphatic group having from 6 to 12 carbons, or a polyether group derived from ethylene, propylene, or butylenes oxides or mixtures thereof having a molecular weight between 120 and 3000.

Representative diamine monomers include the polyether diamines available as the Jeffamine diamines from Huntsman Chemical, ethylenediamine, 1-amino-3aminomethyl-3,5,5-trimethyl cyclohexane, (also referred to herein as isophoronediamine), hexamethylenediamine, 1,12-dodecanediamine, bis(aminomethyl)[2.2.1]bicycloheptane (also referred to herein as norbornanediamine, or NBDA), 2-methylpentamethylenediamine, 2-ethyltetramethylenediamine, 1,2-diaminocyclohexane, 1,3-diaminocyclohexane, cis-1,4-diaminocyclohexane, and trans-1,4-diaminocyclohexane. The isophoronediamine and norbornanediamine (NBDA) are preferred. Mixtures of diamine monomers may be used. The diamine monomer is present from about 0% to about 50% by weight of the pigment.

The Polyamine Monomers

The polyamine monomers typically have the same general structure as the diamine monomers, but contain at least one additional amine group. Mixtures of polyamines may be used.

The Carboxy-Amine Monomers

The carboxyamine monomers contain at least one amine group and at least one carboxylic acid group. Carboxy-amine monomers include p-aminobenzoic acid, and lactones, such as caprolactone. Mixtures of carboxy amine monomers may be used.

The Alkanolamine Monomers

The alkanolamine monomers have the general formula:
OH—R″—NH₂
wherein R″ is a straight or branched chain alklyene group having 2 to 8 carbon atoms. Representative alkanolamine monomers include ethanolamine, butanolamine, n-propanolamine, and isopropanolamine. Monoethanolamine and monoisopropanolamine are preferred. Mixtures of alkanolamine monomers may be used.
The Polyfunctional Alkanolamine Monomers

The polyfunctional alkanolamine monomers have the same general structure as the alkanolamine monomers, but contain at least one additional functional group such as an amine group or alcohol group or carboxylic acid group. Mixtures of alkanolamine monomers may be used.

The Dicarboxylic Acid Monomers

The dicarboxylic acid monomers are the preferred monomer for the source of carboxy groups. The dicarboxylic acid monomer is a dicarboxylic acid or its ester or anhydride derivative of the general formula:
HOOC—R″′—COOH
wherein R″′ is: a straight or branched chain alkylene group of from 3 to 20 carbon atoms; a cycloalkylene group of from 5 to 8 carbon atoms, or a cycloalkylene group with straight chain or branched alkyl carboxy groups optionally having up to three ring substitutions, which may be the same or different, such substitution groups selected from the group consisting of C₁-C₅ alkyl groups; a mono-cyclic or bicyclic arylene group of from 6 to 10 carbon atoms optionally having up to six ring substitutions which may be the same or different, selected from the group consisting of C₁-C₅ alkyl groups; or a C₁-C₂ dialkyl ester or an anhydride of the diacid formed by said monocyclic or bicyclic arylene group.

Representative dicarboxylic acid monomers or ester or anhydride derivatives include phtlialic acid/phthalic anhydride, isophthalic acid, terephthalic acid, 2,6-naphthalene dicarboxylic acid, succinic acid/succinic anhydride, glutaric acid, adipic acid, azelaic acid, sebacic acid, decanedioic acid, dodecanedioic acid, mixtures of succinic, glutaric and adipic acids, cyclohexane dicarboxylic acid, dimethylisophthalate, dimethylphthalate, dimethylterephthalate, dimethyl-2,6-naphthalene dicarboxylate, dimethyladipate, dimethylglutarate, and dimethylsuccinate. Phthalic acid, isophthalic acid and terephthalic acid are preferred. Mixtures of dicarboxylic acid monomers may be used.

The Polyfunctional Carboxylic Acid Monomers

The polyfunctional carboxylic acid monomers have the same general structure as the dicarboxylic acid monomers, but contain at least one additional carboxylic acid group. Mixtures of polyfunctional carboxylic acid monomers may be used.

The Difunctional Alcohol Monomers

The difunctional alcohol monomers have the general formula:
OH—R″″—OH
wherein R″″ is: a straight or branched chain alkylene group having 2 to 20 carbon atoms; a cycloalkylene group having 5 to 8 carbon atoms or a cycloalkylene group with straight chain or branched alkyl alcohol groups and optionally having up to three ring substitutions, which may be the same or different, said ring substitution groups containing alkyl groups having 1 to 5 carbon atoms. Representative difunctional alcohol monomers include: cyclohexandimethanol, ethylene glycol, propylene glycol. Mixtures of difunctional alcohol monomers may be used. The difunctional alcohol monomer is present from 0% to about 60%, preferably from about 0.1% to about 49%, more preferably from 15% to 40%, of the pigment weight.
The Polyfunctional Alcohol Monomers

The polyfunctional alcohol monomers have the same general structure as the difunctional alcohol monomers, but contain at least one additional alcohol group. Mixtures of polyfunctional alcohol monomers may be used. Illustrative polyhydric alcohol monomers include trimethylolpropane, pentaerythritol (available from Celanese) and dipentaerythritol.

The Carboxy-Alcohol Monomers

The carboxy-alcohol monomers contain at least one amine group and at least one alcohol. The carboxy-alcohol monomers include p-hydroxybenzoic acid, 2-chloro-4-hydroxybenzoic acid and salicylic acid.

The ratio of carboxylic acid groups to amine and alcohol groups is preferably 0.75:1 to 1.5:1, more preferably 0.95:1 to 1:1 for polyamide-ester polymers. The ratio of carboxylic acid groups to alcohol groups is preferably 0.75:1 to 1.5:1, more preferably 0.95:1 to 1:1 for polyester pigments.

Chain Terminators

Optionally, chain terminators may be used to control molecular weight and reduce melt viscosity of the resin. Typical chain terminators are benzoic acid, cyclohexylamine, stearic acid, and butanoic acid. Cyclic anhydrides may also be used, which can form cyclic imides with amino functional monomers. Typical cyclic anhydrides are phthalic anhydride or succinic anhydride.

Other Monomers

Other monomers or reactive diluents may be incorporated to impart desired properties to the polymeric dyestuff, such as increasing the molecular weight, altering the softening point, improving compatibility with thermoplastic resins, or lowering the acid number. These may include epoxies, isocyanates, waxes or other reactive monomers.

Preparation of the Polymer

Polymers are prepared by charging the monomers and reactive dyes into a vessel equipped with a means of heating, mechanical stirring, and a condenser to remove the water of reaction. Alternatively, the monomers are charged and the dye added later, however the polymerization reaction must not be completed, so as to permit incorporation of the dye into the backbone of the polymer chain. Both methods produce a pigment containing the dye incorporated into the backbone of the polymer chain.

The polymeric colorants contain 5 to 75%, preferably 10 to 50% chromophore by weight. The ratio of carboxylic acid equivalents to amine or hydroxyl equivalents in the polymeric colorants is 0.9:1 to 1.1:1. Depending on the functionality of the chromophore, either a linear or a branched polymer may be formed. Weight-average molecular weights of the polymeric colorants are in the range of from about 500 to about 100,000, preferably, from about 700 to about 20,000, more preferably from about 1,000 to about 10,000. The molecular weight may be controlled by regulation of the reaction time and temperature, or through the use of chain terminators and polyfunctional monomers. The reactive group on the reactive dye reacts with the functional groups on the monomers. As a result, the dye molecule is incorporated into the backbone of the polymer chain as it is formed. Catalysts to promote esterification or amidization may also be employed.

The polymeric colorants of the present invention are prepared by condensation polymerization reactions illustrated by the following examples. After the pigment is formed, the cooled resin is typically ground to the desirable particle size. The resin has been found to be friable and may be ground to the a particle size as small as 0.5 microns, although it is typically ground to a size of from about 2 to about 100 microns. Grinding is done in a conventional manner.

### EXAMPLE 1

This example demonstrates the in-situ formation of a reactive dye and the use of a pure polyamide resin. A reaction vessel equipped as described above was charged with 50 parts quinizarin, 5 parts leucoquinizarin, 100 parts isophoronediamine, and 100 parts Jeffamine XTJ-500. The reaction was heated to 125-130° C. for one hour to form the anthraquinone dye (see reaction Scheme 1). 73 parts of diethyloxalate was then slowly added, maintaining the temperature between 125 and 145° C. forming polyamide with the loss of ethyl alcohol. The resultant product was a friable blue resin which gave good clarity in polypropylene.

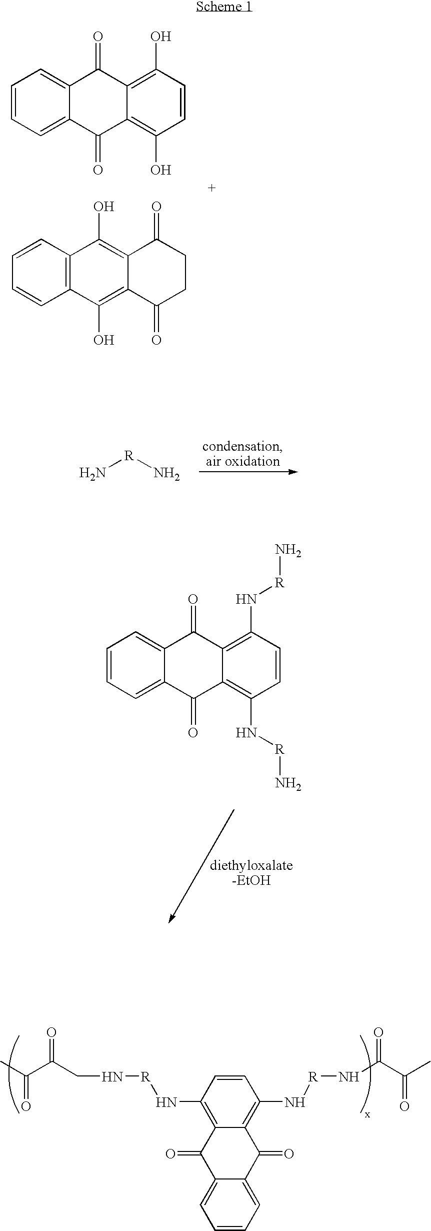

### R=3-methylene-3,5,5-trimethyl-1-cyclohexylene (from isophoronediamine) polypropylene oxide (from Jeffamine)

### EXAMPLE 2

To a reaction vessel described above under a nitrogen blanket, was added 20 parts Solvent Green 5 (structure 1, below), 60 parts polyethyleneglycol 300, and 2 parts esterification catalyst. The mixture was heated to 180° C. After 16 hours at 180° C., 42.5 parts of isophoronediamine and 60 parts adipic acid were added. The reaction was heated to 210° C. for 2 hours to complete the polymerization giving a yellow resin.

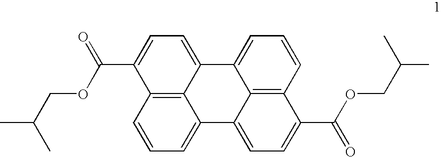

### EXAMPLE 3

To a reaction vessel described above was added 82 parts of a naphthalimide dye 2 containing two reactive hydroxyl groups, 170 parts 1,4-cyclohexanedicaroxylic acid, 60 parts 1,4-cyclohexanedimethanol (90%), and 64 parts isophoronediamine. The reaction mixture was heated to 210° C. for 3 hours giving a yellow polymeric colorant.

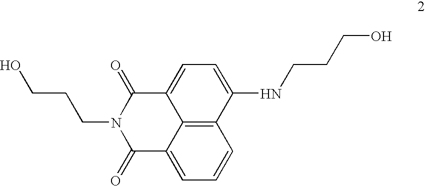

### EXAMPLE 4

A polymeric colorant was prepared as described in Example 3 except the charge was 82 parts 2, 90 parts 1,4-cyclohexanedimethanol (90%), 32 parts isophoronediamine and 170 parts 1,4-cyclohexanedicaroxylic acid.

### EXAMPLE 5

A polymeric colorant was prepared as in example 3 except the charge was 16 parts of a dihydroxyfunctional red anthraquinone 3, 90 parts 1,4-cyclohexanedimethanol (90%), 32 parts isophoronediamine, and 137 parts 1,4-cyclohexanedicarboxylic acid.

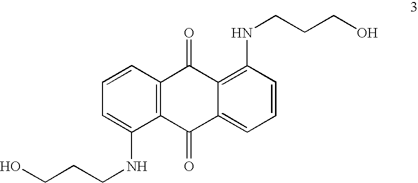

### EXAMPLE 6

A polymeric colorant was prepared as in Example 3 except the charge was 32 parts 3, 80 parts 1,4-cyclohexanedimethanol (90%), 28.5 parts isophoronediamine, and 130 parts 1,4-cyclohexanedicarboxylic acid.

### EXAMPLE 7

A reaction vessel equipped as above was charged with 80 parts 1,4-cyclohexanedimethanol (90%), 28.5 parts isophoronediamine, and 135 parts 1,4-cyclohexanedicarboxylic acid. The mixture was heated to 220° C. for 2 hours, then cooled to 185° C. At this point was added 30 parts of a dihydroxyfunctional blue anthraquinone dye 4 and 2 parts esterification catalyst. The reaction was heated for two hours at 190° C., then cooled to room temperature to provide a blue polymeric colorant.

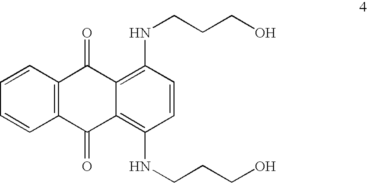

### EXAMPLE 8

A reaction vessel equipped as above was charge with 90 parts 1,4-cyclohexanedimethanol (90%), 16 parts Solvent Green 5 (structure 1), and 1 part transesterification catalyst. The mixture was heated to 180° C. for 24 hours. Then 25 parts isophoronediamine and 123 parts 1,4-cyclohexanedicarboxylic acid were added and the reaction was heated to 210° C. for 2 hours to complete polymerization. The resultant resin was cooled to afford a reddish yellow resin which gave good clarity and color in polypropylene.

### EXAMPLE 9

A polymeric colorant was prepared as in Example 3 except the charge was 10.2 parts of a dihydroxyfunctional violet anthraquinone 5, 90 parts 1,4-cyclohexanedimethanol (90%), 28.5 parts isophoronediamine, and 130 parts 1,4-cyclohexanedicarboxylic acid. Giving a violet polymeric dye which gave good clarity in polypropylene.

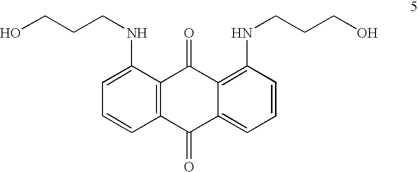

### EXAMPLE 10

A polymeric colorant was prepared as in Example 3 except the charge was 76 parts of benzothioxanthenedicarboxylic anhydride 6, 22 parts 3-amino-1-propanol, 76 parts 1,4cyclohexanedimethanol (90%), 25 parts isophoronediamine, and 128 parts 1,4cyclohexanedicarboxylic acid. The resultant polymeric colorant was orange and gave good clarity in polypropylene.

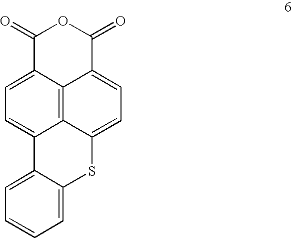

### EXAMPLE 11

A polymeric colorant was prepared as in Example 3 except the charge was 82 parts of a dihydroxyfunctional naphthalimide 2, 110 parts 2-methyl-1,5-pentanediamine, 132 parts cyclohexanedicarboxylic acid, and 85 parts azelaic acid.

### EXAMPLE 12

A polymeric colorant was prepared as in Example 3 except the charge was 82 parts of a dihydroxyfunctional naphthalimide 2, 66 parts 2-methyl-1,5-pentanediamine, 210 parts cyclohexanedicarboxylic acid, and 60 parts 1,4-cyclohexanedimethanol (90%).

### EXAMPLE 13

A polymeric colorant was prepared as in Example 3 except the charge was 82 parts of a dihydroxyfunctional naphthalimide 2, 52.2 parts 2-methyl-1,5-pentanediamine, 204 parts isophthalic acid, and 80 parts 1,4-cyclohexanedimethanol (90%).

### EXAMPLE 14

A polymeric colorant was prepared as in Example 3 except the charge was 82 parts of a dihydroxyfunctional naphthalimide 2, 110 parts 2-methyl-1,5-pentanediamine, 102 parts isophthalic acid, and 112 parts azelaic acid.

### EXAMPLE 15

A polymeric colorant was prepared as in Example 3 except the charge was 82 parts of a dihydroxyfunctional naphthalimide 2, 170 parts 1,4-cyclohexanedicarboxylic acid, 90 parts 1,4-cyclohexanedimethanol (90%), 29.26 parts norboranediamine.

### COMPARATIVE EXAMPLE A

A reaction vessel equipped as described above was charged with 34 parts isophoronediamine, 128 parts 1,4-cyclohexanedimethanol (90%), and 172 parts 1,4-cyclohexanedicarboxylic acid and heated to 220° C. for two hours to polymerize. 60 parts of the dihydroxy functional naphthalimide 2 was then charged, and allowed to dissolve. The resin was immediately cooled to prevent transesterification of the dye with the resin.

### COMARATIVE EXAMPLE B

A resin was prepared according to Comparative Example A, but after polymerization, 40 parts 4 were added to the resin at 190° C. and allowed to dissolve.

### COMPARATIVE EXAMPLE C

A resin was prepared according to Comparative Example A, but after polymerization, 20 parts 1 were added to the resin and allowed to dissolve.

### COMPARATIVE EXAMPLE D

A resin was prepared according to Comparative Example A, but after polymerization, 60 parts Solvent Yellow 33 were added to the resin and allowed to dissolve.

TESTING

Color Migration

The polymeric colorants were incorporated into clarified polypropylene at a level of 0.25% at a molding temperature of 450° F. Clarity of the part was noted. Migration test was performed by placing a 3 in² piece of molded polypropylene between two 0.005″ thick pieces of white plasticized vinyl sheeting under a 500 g weight at 80° C. for 24 hours. Color migration to the white vinyl was noted as a color difference (Delta E).

TABLE 1
Migration Study

| Example | % Colorant | Clarity | Delta E | Bleed through |
|---|---|---|---|---|
| Comparative A | 0.25 | excellent | 4.71 | yes |
| Comparative B | 0.25 | excellent | 4.05 | yes |
| Comparative C | 0.25 | good | 8.54 | yes |
| Comparative D | 0.25 | excellent | 20.96 | yes |
| 3 | 0.25 | good | 0.53 | no |
| 6 | 0.25 | excellent | 0.54 | no |
| 7 | 0.25 | excellent | 1.72 | no |
| 8 | 0.5 | excellent | 0.62 | no |
| 9 | 0.75 | excellent | 0.54 | no |
| 10 | 0.25 | excellent | 2.37 | no |
| 11 | 0.25 | good | 0.32 | no |
| 12 | 0.25 | good | 0.12 | no |
| 13 | 0.25 | good | 0.28 | no |
| 15 | 0.25 | excellent | 0.16 | no |

Clarity Measurements: Excellent—same clarity as uncolored clarified polypropylene as determined visually. Good—slightly more opaque than uncolored clarified polypropylene, but still reasonably clear.

Migration Color Measurement: Color difference between the uncolored white vinyl and the vinyl which was contacted to the polypropylene at 80° C. reported as a Delta E measured by CIELAB coordinates (2° observer, D65 illuminant, HunterLab Miniscan XE). An average of five measurements over the area of contact with the polypropylene were made. If the color migrated all the way through the vinyl sheet, this is noted as “bleed through.”

Solvent Extraction

Solvent extraction was performed by placing a 3 inch×1.5 inch×0.125 inch piece of molded polypropylene in 90 mL acetone at 50° C. for 5 days. The percent of the dye processed into the polypropylene piece that extracted into the acetone is reported in Table 2. The absorbance and wavelength of each sample is also reported.

TABLE 2
Acetone Extraction

| Example | nm | Absorption | % Dye extracted |
|---|---|---|---|
| Comparative A | 437 | 0.0561 | 10.90 |
| Comparative B | 595 | 0.0960 | 29.00 |
| Comparative C | 459 | 0.1288 | 43.50 |
| Comparative D | 436 | 0.8010 | 85.80 |
| 3 | 437 | 0.0170 | 2.30 |
| 4 | 437 | 0.0106 | 1.40 |
| 5 | 522 | 0.0093 | 2.70 |
| 6 | 519 | 0.0099 | 2.90 |
| 7 | 589 | 0.0010 | 1.43 |
| 8 | 451 | 0.0113 | 1.70 |
| 9 | 530 | 0.0043 | 1.30 |
| 10 | 452 | 0.0506 | 9.00 |
| 11 | 437 | 0.0046 | 0.61 |
| 12 | 437 | 0.0075 | 1.00 |
| 13 | 437 | 0.0058 | 0.77 |

As shown, all reacted dyestuffs have significant improvement in both solvent extractability and migration. The notable exception is Example 10, which shows moderate improvement over Comparative Example A. The reason for the poor performance of Example 10 is believed to be the fact that the dyestuff 6 is monofunctional, which terminates each condensation polymer chain, thus limiting the molecular weight of the resin and giving low molecular weight fractions which can migrate and be extracted. The addition of branched polyfunctional monomers could be used to improve on the performance of monofunctional dyes in this application.

### EXAMPLE 16

To a resin kettle equipped with a heating mantle and a mechanical stirrer was added 63.5 parts 1,4-cyclohexanedimethanol, 40 parts norbornanediamine, and 151 parts 1,4-cyclohexanedicarboxylic acid. The reaction was heated to 240° C. for 2 hours. The material was then cooled to 195° C., and 65 parts of dihydroxyfunctional blue anthraquinone dye 4. The resin was cooked at 195° C. for three hours, cooled to 180° C., and 13 parts phenylglycidylether was added and held at 180° C. for 20 minutes. The resin was then cooled and ground to a blue powder.

### EXAMPLE 17

To a resin kettle as above was added 54 parts 1,4-cyclohexanedimethanol, 21 parts 1-ethyl-1,3-propanediamine (available as Dytek EP from DuPont), and 151 parts 1,4-cyclohexanedicarboxylic acid. The reaction was heated to 215° C. for 1 hour, then 105 parts of dihydroxyfunctional red anthraquinone dye 3. Reaction was held for 2.5 hours at 215° C. The reaction was then cooled to 180° C., and 13 parts phenylglycidlyl ether was added and held at temperature for 20 minutes. The resin was then cooled and ground to form a powdered polymeric red colorant.

### EXAMPLE 18

To a resin kettle as above was added 54 parts 1,4-cyclohexanedimethanol, 21 parts 1-ethyl-1,3-propanediamine (available as Dytek EP from DuPont), and 151 parts 1,4-cyclohexanedicarboxylic acid, and 98 parts of naphthalimide dye 2. The reaction was heated for 3 hours at 215° C. The reaction was then cooled to 180° C., and 13 parts phenylglycidlyl ether was added and held at temperature for 20 minutes. The resin was then cooled and ground to form a powdered polymeric yellow colorant.

1. A method of coloring a thermoplastic resin without substantially altering its clarity comprising the steps of:
a) providing a melt comprising a thermoplastic resin;
b) adding one or more polymeric colorants comprising a dye copolymerized into a polymeric resin to the melt; and
c) mixing the thermoplastic resin and the one or more polymeric colorants to form a colored thermoplastic resin;
wherein the polymeric colorant is a solid at room temperature; and
wherein the clarity of the thermoplastic resin is substantially the same as the clarity of the thermoplastic resin before the polymeric colorant is added.

2. The method of claim 1 wherein the difference in clarity between the colored thermoplastic resin and the uncolored thermoplastic resin is less than 5%.

3. The method of claim 2 wherein the difference in clarity between the colored thermoplastic resin and the uncolored thermoplastic resin is less than 1%.

4. The method of claim 1 wherein thermoplastic resin is a clear thermoplastic resin.

5. The method of claim 4 wherein the thermoplastic resin is clarified polypropylene.

6. The method of claim 1 wherein the polymeric colorant is added at a level of less than 2 percent by weight.

7. The method of claim 6 wherein the polymeric colorant is added at a level of less than 1 percent by weight.

8. The method of claim 7 wherein the polymeric colorant is added at a level of less than 0.3% by weight.

9. The method of claim 1 wherein the polymeric resin is selected from the group consisting of polyamides, polyamide-esters, polyesters, and combinations thereof.

10. The method of claim 9 wherein the polymeric resin comprises a linear polymer.

11. The method of claim 9 wherein the polymeric resin comprises a polyamide-ester.

12. The method of claim 1 wherein the polymeric resin comprises 5 to 75% by weight dye.

13. The method of claim 12 wherein the polymeric resin comprises 5 to 35% by weight dye.

14. The method of claim 1 wherein the colored thermoplastic resin has a color migration value, measured as Delta E, of less than 4.

15. The method of claim 14 wherein colored thermoplastic resin has a color migration value of less than 2.5.

16. The method of claim 15 wherein the colored thermoplastic resin has a color migration value of less than 1.5.

17. The method of claim 16 wherein the colored thermoplastic resin has a color migration value of less than 1.

18. The method of claim 17 wherein the colored thermoplastic resin has a color migration value of less than 0.5.

19. A colored thermoplastic resin as prepared by the method of claim 1.

20. A method for imparting a deep color to a thermoplastic resin without substantially altering the clarity of the resin, the method comprising the steps of:
a) providing a melt comprising a thermoplastic resin;
b) adding one or more polymeric colorants to the melt at a level of up to 2% by weight; and
c) mixing the thermoplastic resin and the one or more polymeric colorants to form a deeply colored thermoplastic resin;
wherein the polymeric colorant is a solid at room temperature; and
wherein the clarity of the deeply colored thermoplastic resin is substantially the same as the clarity of the thermoplastic resin before the polymeric colorant is added.

21. The method of claim 20 wherein the thermoplastic resin is clarified polypropylene.

22. The method of claim 20 wherein the difference in clarity between the colored thermoplastic resin and the uncolored thermoplastic resin is less than 5%.

23. The method of claim 22 wherein the difference in clarity between the colored thermoplastic resin and the uncolored thermoplastic resin is less than 1%.

24. The method of claim 20 wherein the polymeric colorant comprises a polymeric resin; the polymeric resin comprising a polymeric backbone and one or more dyes polymerized into the polymeric backbone; wherein the polymeric resin is selected from the group consisting of polyamides and polyester-amides; and wherein the dye is selected from the group consisting of anthraquinones, xanthenes, thioxanthenes, naphthalimides, coumarines, perylenes, methines, azo chromophores, and combinations thereof.

25. The method of claim 24 wherein the polymeric resin comprises a linear polymer.

26. The method of claim 20 wherein the colored thermoplastic resin has a color migration value, measured as Delta E, of less than 4.

27. A method for imparting a deep color to a thermoplastic resin without substantially altering the clarity of the resin, comprising the steps of:
a) providing a melt comprising a thermoplastic resin;
b) adding one or more polymeric colorants to the melt; and
c) mixing the thermoplastic resin and the one or more polymeric colorants to form a colored thermoplastic resin;
wherein the polymeric colorant is a solid at room temperature;
wherein the polymeric colorant comprises a polymeric resin; the polymeric resin comprising a polymeric backbone and one or more dyes polymerized into the polymeric backbone at a level of at least 15% by weight; wherein the polymeric resin is selected from the group consisting of polyamides and polyester-amides; and
wherein the clarity of the deeply colored thermoplastic resin is substantially the same as the clarity of the thermoplastic resin before the polymeric colorant is added.

28. The method of claim 27 wherein the thermoplastic resin is clarified polypropylene.

29. The method of claim 27 wherein the difference in clarity between the colored thermoplastic resin and the uncolored thermoplastic resin is less than 5%.

30. The method of claim 29 wherein the difference in clarity between the colored thermoplastic resin and the uncolored thermoplastic resin is less than 1%.

31. The method of claim 27 wherein the polymeric resin comprises a linear polymeric backbone.

32. The method of claim 27 wherein the dye is selected from the group consisting of anthraquinones, xanthenes, thioxanthenes, naphthalimides, coumarines, perylenes, methines, azo chromophores, and combinations thereof.

33. The method of claim 27 wherein the colored thermoplastic resin has a color migration value, measured as Delta E, of less than 4.

34. A method of coloring a thermoplastic resin without substantially altering the clarity of the thermoplastic resin comprising the steps of:
a) providing a melt comprising a thermoplastic resin;
b) adding one or more polymeric colorants to the melt; and
c) mixing the thermoplastic resin and the one or more polymeric colorants to form a colored thermoplastic resin;
wherein the polymeric colorant comprises a polymeric resin; the polymeric resin comprising a polymeric backbone and one or more dyes polymerized into the polymeric backbone; wherein the polymeric resin is selected from the group consisting of polyamides and polyester-amides;
wherein the polymeric colorant is solid and friable at room temperature; and
wherein the clarity of the colored thermoplastic resin is substantially the same as the clarity of the thermoplastic resin before the polymeric colorant is added.

35. The method of claim 34 wherein the dye is selected from the group consisting of anthraquinones, xanthenes, thioxanthenes, naphthalimides, coumarines, perylenes, methines, azo chromophores, and combinations thereof.

36. The method of claim 35 wherein the dye is a naphthalimide.

37. The method of claim 35 wherein the dye is an anthraquinone.

38. A polymeric colorant for coloring thermoplastic resins without substantially altering the clarity of the thermoplastic resins, the polymeric colorant comprising a polymeric resin, the polymeric resin formed from one or more monomers and one or more dyes;
wherein the monomers have at least two functional groups selected from the group consisting of amine groups, alcohol groups, carboxylic acids, and combinations thereof;
wherein at least some of the monomers are branched polyamides;
wherein the dyes are copolymerized with the monomers and are present in the polymeric colorant at a level of 5 to 75% by weight;
wherein the polymeric colorant is a solid at room temperature; and
wherein the clarity of the thermoplastic resin is not substantially altered when the polymeric colorant is added.

39. The polymeric colorant of claim 38 wherein the dyes are selected from the group consisting of anthraquinones, xanthenes, thioxanthenes, naphthalimides, coumarines, perylenes, methines, azo chromophores, and combinations thereof.

40. The polymeric colorant of claim 38 wherein the polymeric colorant comprises at least 15% by weight dye.

41. The polymeric colorant of claim 40 wherein the polymeric colorant comprises 15 to 25% by weight dye.

42. The polymeric colorant of claim 40 having a weight average molecular weight in the range from 500 to 100,000.

43. The polymeric colorant of claim 42 having a weight average molecular weight in the range from 700 to 20,000.

44. The polymeric colorant of claim 43 having a weight average molecular weight in the range from 1,000 to 10,000.

45. The polymeric colorant of claim 38 having an acid number of 50 or less.

46. The polymeric colorant of claim 38 wherein the polymeric resin comprises a linear resin.

47. A colored thermoplastic resin comprising up to 2% by weight of a polymeric colorant of claim 38.

48. The colored thermoplastic resin of claim 47 wherein the colored thermoplastic resin has a color migration value, measured as Delta E, of less than 4.

49. The colored thermoplastic resin of claim 48 wherein the colored thermoplastic resin is clarified polypropylene.
